(19) United States
(12) Patent Application Publication
(10) Pub. No.: US 2026/0339828 A1
(43) Pub. Date: Oct. 29, 2026

(54) SOFTWARE TESTING METHOD AND SOFTWARE TESTING APPARATUS

(71) Applicant: Rou-Fang Wang, Taipei City (TW)

(72) Inventor: Rou-Fang Wang, Taipei City (TW)

(21) Appl. No.: 19/550,274

(22) Filed: Feb. 26, 2026

(30) Foreign Application Priority Data
Feb. 27, 2025 (TW) 114107299

(51) Int. Cl. G06F 11/3668; G06F 21/57

(52) U.S. Cl. CPC G06F 11/3688; G06F 11/3696; G06F 21/577

(57) ABSTRACT

A software testing method and a software testing apparatus are provided. The method includes: according to multiple items on an operating interface of a software-under-test (SUT), generating multiple test actions executable on the items; creating a software testing interface, defining multiple play actions of a tester in the software testing interface and matching the play actions to the test actions of the SUT; determining an importance of each of the test actions according to one or more execution sections in a program code of the SUT, or software function/performance/use-experience/security requirements corresponding to the test action; predicting a reward obtainable by executing each of the play actions according to the importance of the test action matched by each of the play actions, and displaying the reward on the software testing interface; and feeding back the reward in response to receiving an execution result of the play action.

### CROSS-REFERENCE TO RELATED APPLICATION

This application claims the priority benefit of Taiwan application serial no. 114107299, filed on Feb. 27, 2025. The entirety of the above-mentioned patent application is hereby incorporated by reference herein and made a part of this specification.

### BACKGROUND

### Technical Field

The disclosure relates to a testing method and a device, and more particularly to a software testing method and a software testing device.

### Description of Related Art

Software testing is a very critical and complex process, because it involves ensuring that software products may operate stably and reliably under different scenarios. In this process, testers face many challenges. Among them, since different software versions, hardware configurations, operating system versions, etc. all affect test results, the test environment must remain consistent with the development environment and user environment in order to ensure consistency and reproducibility of test results. As the scale and functionality of software systems continue to grow, testing becomes more complex. How to ensure that each element and function is fully tested and potential defects are found is a major challenge in the field of software testing.

In order to obtain effective test results, a large amount of test data is often required. This data needs to be authentic and conform to user scenarios, but due to the difficulty in collecting, generating and managing test data, many software developers face resource challenges such as insufficient testing time, limited testers, and inadequate testing equipment. Moreover, if testing work is outsourced, testers may directly view various designs of the application/webpage/interface to be tested before the application/webpage is released, which may result in the risk of intellectual property (IP) leakage.

Therefore, how to improve the extensiveness and concealment of testing, allowing external testers to participate in testing and efficiently perform testing operations without leaking content of the software, thereby generating clear and accurate reports that enable management and development teams to quickly understand the quality status of software, is a significant challenge.

### SUMMARY

The disclosure provides a software testing method and a software testing device, which may increase software testing resources and enhance software testing performance.

The disclosure provides a software testing method applicable to an electronic device having a processor. The method includes the following steps. Multiple test actions executable on multiple items are generated according to the items on a user interface of a software-under-test (SUT). A software testing interface is created, defining multiple play actions of a tester in the software testing interface, and matching the play actions to multiple test actions of the software-under-test. According to one or more execution sections in a program code of the software-under-test corresponding to each of the test actions, or according to a requirement for a software functionality/performance/user experience/information security, an importance of the test action is determined. According to the importance of the test action matched by each of the play actions, a reward obtainable by executing each of the play actions is predicted and prompted in the software testing interface. The reward is fed back in response to receiving an execution result of the play action.

The disclosure provides a software testing device, which includes a display device, an input device, a storage device and a processor. The input device is configured to receive an operation of a user. The storage device is configured to store a computer program. The processor is coupled to the display device, the input device and the storage device, and is configured to load and execute the computer program to: generate multiple test actions executable on multiple items according to the items on a user interface of a software-under-test; create a software testing interface, define multiple play actions of a tester in the software testing interface, and match the play actions to multiple test actions of the software-under-test; determine an importance of the test actions according to one or more execution sections in a program code of the software-under-test corresponding to each of the test actions, or according to a requirement for a software functionality/performance/user experience/information security; predict a reward obtainable by executing each of the play actions according to the importance of each of the test actions matched by each of the play actions, and prompt the reward in the software testing interface; and feed back the reward in response to receiving an execution result of the play action.

The software testing method and the software testing device of the disclosure, by converting the play actions performed by testers in the software testing interface to the test actions of the software-under-test, predict a reward obtainable by executing each of the play actions according to the importance of the test action, and provide feedback to testers through score and audio-visual effects or compensation, thereby enabling external testers to also participate in testing, thus increasing software testing resources and enhancing software testing performance.

To make the above features and advantages of the disclosure more apparent and understandable, embodiments are specifically provided below and described in detail with accompanying drawings as follows.

### BRIEF DESCRIPTION OF THE DRAWINGS

FIG. 1 is an example of a software testing interface illustrated according to an embodiment of the disclosure.

FIG. 2 is a block diagram of a software testing device illustrated according to an embodiment of the disclosure.

FIG. 3 is a flowchart of a software testing method illustrated according to an embodiment of the disclosure.

FIG. 4 is a flowchart of a method for predicting rewards of play actions illustrated according to an embodiment of the disclosure.

FIG. 5 is a schematic diagram of a conversion mechanism illustrated according to an embodiment of the disclosure.

### DESCRIPTION OF THE EMBODIMENTS

The software testing method and the software testing device of the embodiments of the disclosure provide a conversion mechanism between the user interface of the software-under-test (web pages or applications) and a software testing interface (for example, a game user interface), allowing rewards obtained by testers performing play actions in the software testing interface to reflect the importance of test actions of the software-under-test. The importance may reflect test coverage, software design flaws, software function/performance/user experience/information security requirements, and confirmation of program error locations. Embodiments of the disclosure may further provide various different software to be very easily connected to the testing platform through designing related application programming interfaces (APIs), to provide diverse game interface experiences for rapid conversion and options.

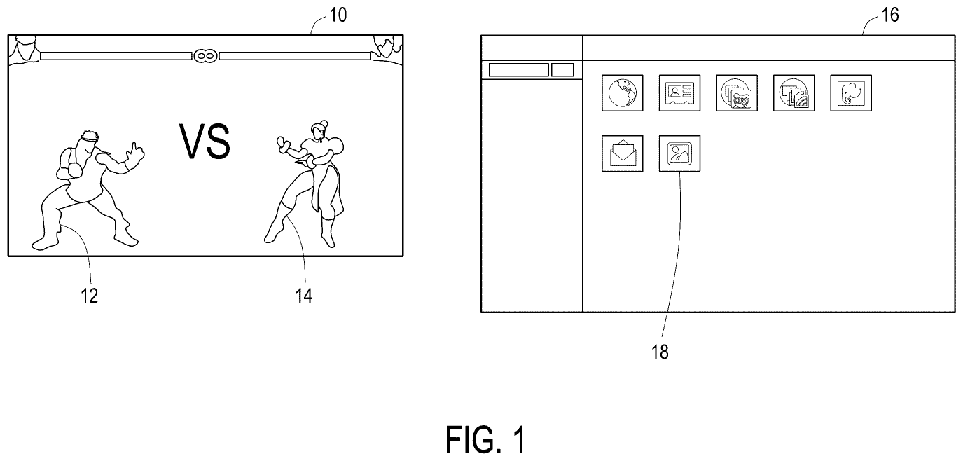

For example, FIG. 1 is an example of a software testing interface illustrated according to an embodiment of the disclosure. Referring to FIG. 1, this embodiment uses, for example, a user interface 10 of a fighting game as the software testing interface, where a player may operate a character 12, and an opponent 14 represents a program-under-test 16. The program-under-test 16 is, for example, a web page to be tested, which includes operation items 18 such as buttons, icons, and data input. Embodiments of the disclosure provide a simple and easy-to-learn user interface 10, converting actions of the character 12 in the fighting game into button or text operations on the program-under-test 16, and guiding the player to execute high-value test actions by predicting in advance the score and feedback that the player may obtain by executing each action. In addition, by evaluating the actual contribution after the player executes test actions, audio-visual effects are used to provide sensory feedback, thereby enhancing the player's motivation and interest in executing tests.

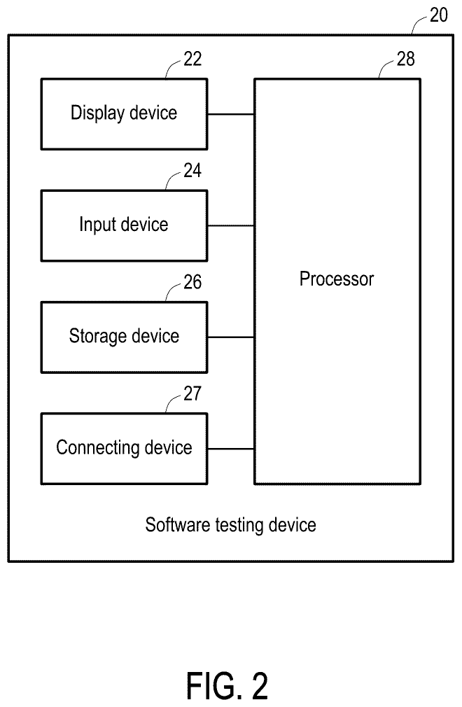

FIG. 2 is a block diagram of a software testing device illustrated according to an embodiment of the disclosure. Referring to FIG. 2, a software testing device 20 of this embodiment is, for example, a computer device with computing capability such as a file server, database server, application server, workstation, or personal computer, or a mobile device such as a mobile phone or tablet computer, and this embodiment does not limit the type thereof. The software testing device 20 includes elements such as a display device 22, an input device 24, a storage device 26, a connecting device 27, and a processor 28, and the functions of these elements are described as follows:

The display device 22 is, for example, a display or a television that uses a liquid crystal display (LCD), light-emitting diode (LED), field emission display (FED), or other types of panels as the display panel, and uses a cold cathode fluorescent lamp (CCFL) or light-emitting diode as the backlight module, without limitation herein.

The input device 24 is, for example, input tools such as a keyboard, mouse, remote controller, joystick, touchpad, or touch screen that may detect user input operations, a microphone that may recognize user speech, a camera that may parse player images and gestures to obtain player expressions/actions, or augmented reality/virtual reality (AR/VR) devices, without limitation herein. In some embodiments, the input device 24 is, for example, a touch panel, and may be integrated with the display device 22 as a touch screen to simultaneously provide display and operation functions. In other embodiments, the input device 24 may interpret user's instruction from the user speech recognized by the microphone and accordingly provide a voice control function to the software testing device 20.

The storage device 26 is, for example, any type of fixed or removable random access memory (RAM), read-only memory (ROM), flash memory, hard disk, or similar elements or a combination of the above elements, and is used to store computer programs executable by the processor 28 and data used thereby.

The connecting device 27 is, for example, a wired connecting device such as universal serial bus (USB), RS232, universal asynchronous receiver/transmitter (UART), inter-integrated circuit (I2C), serial peripheral interface (SPI), display port, thunderbolt, or local area network (LAN) interface, or a wireless connecting device supporting communication protocols such as wireless fidelity (Wi-Fi), RFID, Bluetooth, infrared, near-field communication (NFC), or device-to-device (D2D), used to connect to the Internet and connect through the Internet or physically connect to electronic devices (such as web servers) installed or configured with software-under-test, to access the software-under-test and test the software-under-test. This embodiment does not limit the type and connection method of the connecting device 27.

The processor 28 is, for example, a central processing unit (CPU), or other programmable general-purpose or special-purpose microprocessor, microcontroller, digital signal processor (DSP), programmable controller, application specific integrated circuits (ASIC), programmable logic device (PLD), graphics processing unit (GPU), or other similar devices or combinations of these devices, but this embodiment is not limited thereto. In this embodiment, the processor 28 may load computer programs from the storage device 26 to execute the software testing method of the embodiments of the disclosure.

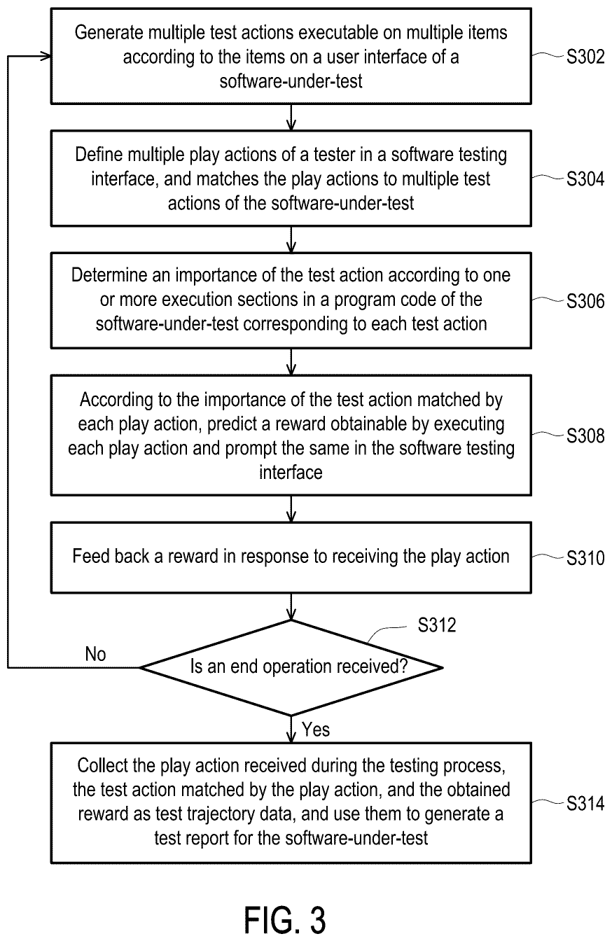

FIG. 3 is a flowchart of a software testing method according to an embodiment of the disclosure. Referring to FIG. 2 and FIG. 3 simultaneously, the method of this embodiment is applicable to the software testing device 20. The detailed steps of the software testing method of this embodiment will be described below in conjunction with the elements of the software testing device 20.

In step S302, the software testing device 20 generates, by the processor 28, multiple test actions executable on multiple items according to the items on the user interface of the software-under-test. The items are, for example, buttons, icons, input fields, text descriptions, screen sliding operations, or device physical buttons in the user interface, and correspondingly, the test actions are, for example, pressing buttons, pressing device physical buttons, sliding screen, clicking icons, or inputting text, etc. This embodiment does not limit the types of items and test actions.

In step S304, the processor 28 creates a software testing interface, defines multiple play actions of a tester in the software testing interface, and matches the play actions to multiple test actions of the software-under-test.

In some embodiments, the software testing interface is, for example, a game user interface. The play actions of the tester are, for example, fighting actions and moves that a player controls a character to execute in the game user interface, and the test actions matched with the play actions are, for example, actions or responses (visual or auditory effects) of an opponent after being hit by the character, which may correspond to operations on buttons and icons in the user interface.

In step S306, the processor 28 determines the importance of test actions according to one or more execution sections in the program code of the software-under-test corresponding to each test action.

In step S308, the processor 28 predicts rewards obtainable by executing each play action according to the importance of test actions matched by each play action, and prompts the rewards in the software testing interface.

In some embodiments, the processor 28 may further determine the importance of test actions according to requirements in software functionality/performance/usage experience/information security, and accordingly predict rewards obtainable by executing each play action. This embodiment does not limit the method thereof. Detailed reward prediction/calculation methods will be described in the embodiments later.

In step S310, the processor 28 feeds back the rewards in response to receiving execution results of play actions.

In step S312, the processor 28 determines whether an end operation is received. If no end operation is received, the process returns to step S302 to regenerate test actions executable on items on the updated user interface and predict rewards for executing play actions. In detail, during the testing process, the software-under-test will transition between different screen states. Therefore, after each play action is executed, the processor 28 will recalculate the layout of multiple items on the user interface according to the screen state after execution, and predict rewards obtainable by the tester executing play actions.

In step S314, if it is determined that an end operation is received, the processor 28 will collect the play actions received during the testing process, the test actions matched by the play actions, and the obtained rewards as test trajectory data, and use them to generate a test report for the software-under-test.

For example, embodiments of the disclosure may provide checkout prediction/notification/accounting services for testing outsourcing. After the tester ends all games, the processor 28 may transmit all test trajectory data to the testing outsourcing team through a certain issue report format, and obtain testing outsourcing service fees or obtain confirmation of service fee amounts to be paid by the testing outsourcing team according to bilateral cooperation agreements. Once the amount is confirmed, the processor 28 may notify the player through the game interface or other second channels (such as email, phone text messages, communication software, etc.). Through real-time notifications, players can obtain income satisfaction after obtaining game satisfaction, thereby gradually making them like the testing outsourcing service cooperation model, and further consolidating the user community ecosystem of the testing outsourcing service platform based on game conversion technology in this embodiment.

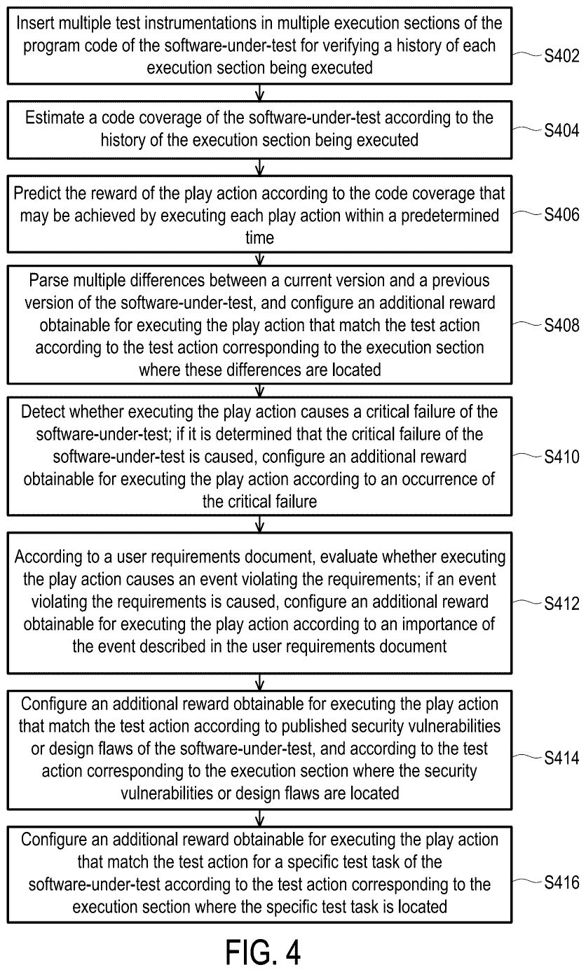

FIG. 4 is a flowchart of a method for predicting rewards of play actions according to an embodiment of the disclosure. Referring to FIG. 2 and FIG. 4 simultaneously, the method of this embodiment is applicable to the software testing device 20.

In step S402, the software testing device 20 uses the processor 28 to insert multiple test instrumentations in multiple execution sections of the program code of the software-under-test, for verifying the history of each execution section being executed. The history includes whether it has been executed, the number of times it has been executed, and variable data when executed, etc., which is not limited herein.

In step S404, the processor 28 estimates the code coverage of the software-under-test according to the history of the execution sections being executed.

In some embodiments, the code coverage includes source code coverage, and the program code may be C++, C, Java, Basic, Python, objective-C, Swift, PHP, Javascript, etc. for mobile computing. The processor 28, for example, divides the program code into single-entry-single-exit (SESE) execution sections. The code coverage may be defined as what percentage of SESE execution sections are executed at least once.

The production aspect may be considered from the following two perspectives:
I. Client-side code coverage: This part may answer which program segments have been executed, how many times they have been executed, variable data during execution, and other data through inserting instrumentations in the program code of the software-under-test. Such answers may be recorded in files, may also be directly written on the screen, or may be reported to the conversion module through application program interface (API).
II. Server-side code coverage: This part may be queried from the server through network requests (HTTP request).

In some embodiments, the code coverage includes binary code coverage. Usually when source code coverage is not available, specific tools may also be used to estimate the coverage of binary code. Similar to source code coverage, SESE execution sections of binary code may also be defined. This part may also be directly estimated through certain tools, or reported by pre-inserted program code.

The production aspect may also be considered from the following two perspectives:
I. Client-side binary code coverage: This part may also answer which program segments have been executed, how many times they have been executed, variable data during execution, and other data through inserting instrumentations in the test version of the program. Such answers may be recorded in files, may also be directly written on the screen, or may be reported to the conversion module through application program interface (API).
II. Server-side binary code coverage: This part may be queried from the server through network requests.

Returning to the flow of FIG. 4, in step S406, the processor 28 predicts the reward of play actions according to the code coverage that may be achieved by executing each play action within a predetermined time.

In detail, the tester obtains a prediction of the reward obtainable for each play action. The reward may be converted into possible scores that the tester may obtain for various selectable play actions seen on the screen, and guides the tester to take play actions that may lead to the most valuable test report.

For example, under the estimation of source code coverage or binary code coverage, the processor 28 may adopt the following summation formula to estimate the reward for executing a certain play action a:

reward=SUM ₑ len(e)/(2^{k}),

wherein e represents all uncovered and reachable from a within k steps.

The above formula may predict the play action a that achieves the highest coverage within a short time.

For example, according to the execution flow chart of the program to predict the screen that each play action may lead to, whether it may include feature/performance requirement items specified in the user requirements document, or may include execution of disclosed security-sensitive permissions/data, or may include key features according to user experience, etc. If it may lead to such situations, the processor 28 may assign a higher prediction score to the play action.

In the presentation of predicted scores, the processor 28 may provide prompts through visual/auditory techniques such as color temperature, patterns (such as trophies, garlands, ice cream, lollipops), etc.

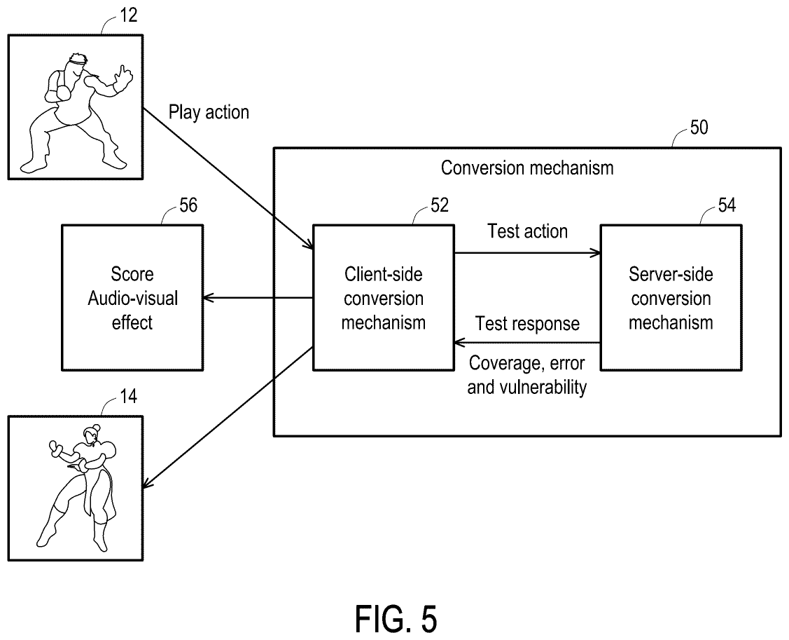

FIG. 5 is a schematic diagram of a conversion mechanism according to an embodiment of the disclosure. Referring to FIG. 5, this embodiment divides a feedback mechanism 50 for tester rewards into two parts, one part is a client-side conversion mechanism 52, and the other part is a server-side conversion mechanism 54. Among them, the tester implements play actions by operating the character 12, and these play actions will be converted into test actions by the client conversion mechanism 52 and provided to the server-side conversion mechanism 54. The server-side conversion mechanism 54 generates test responses, including coverage, errors and vulnerabilities, etc., and provides them to the client conversion mechanism 52. Finally, the client conversion mechanism 52 provides feedback to the actions of the opponent 14 representing the program-under-test, and displays scores and audio-visual effects 56 on the user interface 10 as rewards for the tester executing play actions. The purpose of the feedback mechanism 50 is to make the value of the test report reflect in the scores obtained by the tester and the sensory stimulation intensity of the audio-visual effects.

It should be noted that if the software-under-test is a standalone application program, the above client conversion mechanism 52 and server-side conversion mechanism 54 can be combined into one.

In the embodiment of FIG. 4, in addition to the above rewards for predicting play actions based on code coverage, the processor 28 may also configure additional rewards that the tester may obtain for executing play actions according to updated elements, critical failures, requirement violations, design defects, specific test tasks, etc.

In step S408, the software testing device 20 uses the processor 28 to parse multiple differences between the current version and the previous version of the software-under-test, and configures additional rewards obtainable for executing play actions that match test actions according to test actions corresponding to execution sections where these differences are located. The above differences include newly added screen elements, newly added program code, modified execution sections, etc., and this embodiment does not limit the types thereof.

In detail, the embodiment of the disclosure may track newly added screen elements, modified SESE, and newly added program code during the debug process or version update process, and give additional high scores to guide testers to trigger play actions to achieve testing of program functions affected by version updates.

In step S410, the software testing device 20 uses the processor 28 to detect whether executing play actions causes critical failures of the software-under-test. Among them, if it is determined that critical failures of the software-under-test are caused, the processor 28 configures additional rewards obtainable for executing play actions according to the number of occurrences of critical failures. The above failures include crashes, freezes, important data corruption, or sensitive data leakage, but this embodiment is not limited thereto.

In detail, critical failures of the software-under-test (SuT) usually represent that the software-under-test loses functionality, such as crashes, freezes (loss of response), important data corruption, sensitive data leakage, etc. Among them, if this critical failure has never been reported before, the embodiment of the disclosure may give a higher feedback score; but if it is a critical failure that has been repeatedly reported, the feedback score may be appropriately reduced.

In step S412, the software testing device 20 uses the processor 28 to evaluate whether executing play actions causes events that violate requirements according to user requirements documents. Among them, if events that violate requirements are caused, the processor 28 configures additional rewards obtainable for executing play actions according to the importance of the events described in the user requirements documents. The above events include file upload failures, video playback failures, animation failures, button color non-compliance, absence of specially designated buttons, or execution performance not meeting standards, but this embodiment is not limited thereto.

In detail, the embodiment of the disclosure may evaluate requirement violation situations according to user requirements documents, such as file upload failures, video playback failures, animation failures, button colors not conforming to requirement document descriptions, specially designated buttons failing to appear on the screen, execution performance not meeting standards, etc. If such situations are determined to occur, feedback scores may also be appropriately given according to the importance of such events described in the user requirements documents.

In step S414, the software testing device 20 uses the processor 28 to configure additional rewards obtainable for executing play actions that match test actions according to published security vulnerabilities or design flaws of the software-under-test, and according to test actions corresponding to execution sections where the security vulnerabilities or design flaws are located.

The above security vulnerabilities are, for example, OWASP top 10 security vulnerabilities, or security vulnerabilities published on CVE. The above design flaws are, for example, published design defects of certain software elements. The embodiment of the disclosure does not limit the sources and types of security vulnerabilities or design flaws.

In step S416, the software testing device 20 uses the processor 28 to configure additional rewards obtainable for executing play actions that match test actions for specific test tasks of the software-under-test, according to test actions corresponding to execution sections where the specific test tasks are located. The above specific test tasks include performance tests, specific business process tests, stress tests, or load tests, but this embodiment is not limited thereto.

In detail, in the test outsourcing business of the software-under-test, if specific-purpose test tasks are selected, such as performance tests, specific business process tests, stress tests, load tests, etc., the embodiment of the disclosure may grant testers greater rewards after operations that lead to the fulfillment of part of the testing objective have been completed.

In some embodiments, the software testing device 20 uses the processor 28 to determine that the software-under-test exhibits failed design according to general usage culture and user experience. For example, when file downloads require excessive time, lacking progress display (such as rotating hourglass, digital clock, pointer clock, etc.), causing users to suspect whether the system has stopped responding. Another example is failing to display account login status, causing users to not know whether login has been completed. Another example is screen element arrangement lacking aesthetics. Another example is certain screen element images that confuse users and cause bewilderment. The embodiment of the disclosure may give testers greater rewards when determining that the software-under-test exhibits failed design.

In some embodiments, a grouping relationship between test operations of the software-under-test and play actions of players may be additionally established. Since under a certain execution state of the software-under-test, there may be many test operations that may be adopted, for example, a shopping page may have dozens of categorized menu items (such as men's clothing, women's clothing, children's clothing, . . . ) and hundreds of product item photos; there may also be very few, for example, on a two-factor authentication screen there may be only one one-time password (OTP) input field and one OK button.

And testers under a certain software testing interface (for example, game screen) may adopt many play actions, for example, in card games, there may be dozens of cards that may be played; for example, in Go games, there may be hundreds of placement points; for example, during the falling process in Tetris, there are multiple positions and rotation directions that may be selected, etc.; play actions may also be very few, for example, in fighting games, there may be only several moves that may be executed; for example, in pacman games, one may only choose to stop or move left, up, down, or right.

According to the above, the embodiment of the disclosure may group several test operations to the same play action; or conversely group several play actions to the same test action. As for what grouping mechanism should be adopted, the following embodiments are described in detail.

In some embodiments, when test operations are more than play actions: the processor 28 of the software testing device 20 matches multiple test actions executed for multiple items with the same or similar properties to the same play action, and in response to receiving the play action, uses maximizing reward, fuzzing, random, or security data transformation (such as XSS, SQL injection) methods to select one from the multiple test actions matched by the play action for execution.

In detail, when test operations are more than play actions, the embodiment of the disclosure may correspond functionally similar test operations to the same play action, for example, corresponding all product option elements to one or multiple play actions, and these play actions will accept test operations of product option elements; on the other hand, test operations related to checkout, such as shopping cart, checkout, order inquiry, etc., may correspond to another play action.

In some embodiments, the processor 28 may determine the standard for matching multiple test actions to the same play action according to the predicted rewards obtainable by executing each test action. For example, certain play actions only correspond to test actions with higher predicted rewards, and certain play actions only correspond to test operations with lower rewards.

In some embodiments, when the tester selects a certain play action, the processor 28 may select the test operation with the highest predicted feedback score from the test operations matched with this play action for execution, or use fuzzing, random methods, or security data transformation methods to select test operations, and this embodiment does not limit the selection method.

In some embodiments, when test operations are more than play actions: the processor 28 of the software testing device 20 matches multiple play actions with the same or similar features to the same test action, and according to the importance of the test action, predicts rewards obtainable by executing the multiple play actions, thereby responding to receiving one of the multiple play actions by feeding back the reward.

In detail, when test operations are fewer than play actions, the embodiment of the disclosure may correspond play actions with similar image/orientation/sound features to the same test operation, and according to the predicted reward (for example, feedback score) of the test operation, add special audio-visual effects to its corresponding play actions. Thus, after multiple uses of the software testing interface (for example, game interface), the tester may become familiar with what type of play actions may trigger what type of test operations.

In some embodiments, the processor 28 may configure multiple sessions for performing play actions using the software testing interface, and according to the rewards accumulated by executing play actions in one of the multiple sessions, determine whether to proceed to the next session or end the operation (game over).

In detail, the embodiment of the disclosure may allow the tester to select the time to end the test, or know the expected time for the test to end. For example, the following mechanisms or procedures may be used:
A. Sessions may be established in the game, with each session having different backgrounds, music, characters, weapons, treasures, scores, etc.
B. A time or target score budget may be set in each game session, corresponding to the test budget of the test session. When the player cannot obtain the target score within the limited time, it may be determined that the player fails and the game ends. At this time, the player may decide whether to replay another game session. However, if the player achieves the score target within the time or budget, appropriate rewards or audio-visual effect incentives may be given, and the player proceeds to the next game stage.

In some embodiments, the processor 28 may determine whether to switch the software testing interface to another software testing interface according to the rewards accumulated by executing play actions in the software testing interface.

In detail, the embodiment of the disclosure may allow the tester to select different software testing interfaces during the testing process, for example, converting from the interface of a pacman game to the interfaces of games such as simcity, social games, fighting games, Tetris, etc., and then accumulating scores in these different games respectively, and even participating in the world leaderboard of such test outsourcing conversion games.

In summary, in the software testing method and software testing device of the embodiment of the disclosure, through the conversion mechanism between the operation interface of the software-under-test (web page or application program) and the software testing interface (for example, game operation interface), the intellectual property rights of the application program and its developers may be protected, allowing a large number of game players to also participate in the software testing outsourcing industry, expanding the territory of software testing human resources. In addition, the embodiment of the disclosure may also allow testers to combine work with games, thereby stimulating maximum testing performance, and through cooperation with major game production venues worldwide, cross-domain inter-industry combination benefits may be generated.

Although the disclosure has been disclosed above with embodiments, they are not intended to limit the disclosure. Any person having ordinary knowledge in the technical field may make slight modifications and refinements without departing from the spirit and scope of the disclosure. Therefore, the protection scope of the disclosure shall be defined by the appended claims.

What is claimed is:

1. A software testing method, applicable to an electronic device having a processor, wherein the method comprises:
according to a plurality of items on a user interface of a software-under-test, generating a plurality of test actions executable on the plurality of items;
creating a software testing interface, defining a plurality of play actions of a tester in the software testing interface, and matching the plurality of play actions to the plurality of test actions of the software-under-test;
according to one or a plurality of execution sections in a program code of the software-under-test corresponding to each of the plurality of test actions, determining an importance of the test action;
according to the importance of the test action matched by each of the plurality of play actions, predicting a reward obtainable by executing each of the plurality of play actions, and prompting the reward in the software testing interface; and
in response to receiving an execution result of the play action, feeding back the reward.

2. The method of claim 1, wherein determining the importance of the test action according to one or a plurality of execution sections of the program code of the software-under-test corresponding to each of the plurality of test actions and predicting the reward obtainable by executing each of the plurality of play actions according to the importance of the test action matched by each of the plurality of play actions comprise:
inserting a plurality of test instructions in the plurality of execution sections of the program code of the software-under-test for verifying a history of each of the plurality of execution sections being executed, wherein the history comprises whether executed, an execution count, and a variable data during an execution;
according to the history of the execution section being executed, estimating a code coverage of the software-under-test; and
according to the code coverage achievable by executing each of the plurality of play actions within a predetermined time, predicting the reward of the play action.

3. The method of claim 2, wherein the code coverage comprises a source code coverage and a binary code coverage, and comprises a distinction between a client side and a server side.

4. The method of claim 1, further comprising:
parsing a plurality of differences between a current version and a previous version of the software-under-test, and according to the test action corresponding to the execution section where the plurality of differences are located, configuring an additional reward obtainable by executing the play action matching the test action, wherein the plurality of differences comprise a newly added screen element, a newly added program code, and a modified execution section.

5. The method of claim 1, further comprising:
detecting whether executing the play action causes a critical failure of the software-under-test; and
if the critical failure of the software-under-test is caused, according to an occurrence count of the critical failure, configuring the reward given for executing the play action, wherein the critical failure comprises a crash, a freeze, an important data corruption, or a sensitive data leakage.

6. The method of claim 1, further comprising:
according to a user requirements document, evaluating whether executing the play action causes an event violating a requirement; and
if the event violating the requirement is caused, according to an importance of the event described in the user requirements document, configuring the reward given for executing the play action, wherein the event comprises a file upload failure, a video playback failure, an animation failure, a button color mismatch, an absence of a specially designated button, or a performance not meeting a standard.

7. The method of claim 1, further comprising:
according to a published security vulnerability or a design flaw of the software-under-test, and according to the test action corresponding to the execution section where the security vulnerability or the design flaw are located, configuring an additional reward obtainable by executing the play action matching the test action.

8. The method of claim 1, further comprising:
for a specific test task of the software-under-test, according to the test action corresponding to the execution section where the specific test task is located, configuring an additional reward obtainable by executing the play action matching the test action, wherein the specific test task comprises a performance testing, a specific business process testing, a stress testing, or a load testing.

9. The method of claim 1, further comprising:
matching a plurality of test actions executed for a plurality of items with a same or similar property to the same play action; and
in response to receiving the execution result of the play action, adopting a method of maximizing the reward, fuzzing, random, or security data mutation to select one from the plurality of test actions matched by the play action for execution.

10. The method of claim 9, wherein matching the plurality of test actions executed for the plurality of items with the same or similar property to the same play action comprises:
according to a predicted reward obtainable by executing each of the plurality of test actions, determining a criteria for matching the plurality of test actions to the same play action.

11. The method of claim 1, further comprising:
matching a plurality of play actions with a same or similar feature to the same test action, and according to the importance of the test action, predicting a reward obtainable by executing the plurality of play actions so as to respond to receiving an execution result of one of the plurality of play actions by feeding back the reward.

12. The method of claim 1, further comprising:
configuring a plurality of sessions for performing the play action using the software testing interface; and
according to the reward accumulated by executing the play action in one of the plurality of sessions, determining whether to proceed to a next session or end an operation.

13. The method of claim 1, further comprising:
according to the reward accumulated by executing the play action in the software testing interface, determining whether to switch the software testing interface to another software testing interface.

14. The method of claim 1, further comprising:
in response to receiving an end operation, collecting the play action received during the testing process, the test action matched by the play action, a system-under-test reaction, and an obtained reward as test trajectory data, thereby generating a test report of the software-under-test.

15. A software testing device, comprising:
a display device;
an input device, receiving an operation of a user;
a storage device, storing a computer program; and
a processor, coupled to the display device, the input device, and the storage device, and configured to load and execute the computer program to:
according to a plurality of items on a user interface of a software-under-test, generate a plurality of test actions executable on the plurality of items;
create a software testing interface, define a plurality of play actions of a tester in the software testing interface, and match the plurality of play actions to the plurality of test actions of the software-under-test;
according to one or a plurality of execution sections in a program code of the software-under-test corresponding to each of the plurality of test actions, determine an importance of the test action;
according to the importance of the test action matched by each of the plurality of play actions, predict a reward obtainable by executing each of the plurality of play actions, and prompting the reward in the software testing interface; and
in response to receiving an execution result of the play action, feed back the reward.

16. The software testing device of claim 15, wherein the processor inserts a plurality of test instructions in the plurality of execution sections of the program code of the software-under-test for verifying a history of each of the plurality of execution sections being executed, the history comprising whether executed, an execution count, and a variable data during an execution, wherein the processor, according to the history of the execution section being executed, estimates a code coverage of the software-under-test, and, according to the code coverage achievable by executing each of the plurality of play actions within a predetermined time, predicts the reward of the play action, wherein the code coverage comprises a source code coverage and a binary code coverage, and comprises a distinction between a client side and a server side.

17. The software testing device of claim 15, wherein the processor further parses a plurality of differences between a current version and a previous version of the software-under-test, and, according to the test action corresponding to the execution section where the plurality of differences are located, configures an additional reward obtainable by executing the play action matching the test action, wherein the plurality of differences comprise a newly added screen element, a newly added code, and a modified execution section.

18. The software testing device of claim 15, wherein the processor further detects whether executing the play action causes a critical failure of the software-under-test, and, if the critical failure of the software-under-test is caused, according to an occurrence count of the critical failure, configures the reward given by executing the play action, wherein the critical failure comprises a crash, a freeze, an important data corruption, or a sensitive data leakage.

19. The software testing device of claim 15, wherein the processor, according to a user requirements document, further judges whether executing the play action causes an event violating a requirement, and, if the event violating the requirement is caused, according to an importance of the event described in the user requirements document, configures the reward given by executing the play action, wherein the event comprises a file upload failure, a video playback failure, an animation failure, a button color mismatch, an absence of a specially designated button, or a performance not meeting a standard.

20. The software testing device of claim 15, wherein the processor, in response to receiving an end operation, further collects the play action received during a testing process, the test action matched by the play action, a reaction of a program-under-test, and an obtained reward as test trajectory data, thereby generating a test report of the software-under-test.
